(19) United States
(12) Patent Application Publication
(10) Pub. No.: US 2025/0220081 A1
(43) Pub. Date: Jul. 3, 2025

(54) INTERACTING SYSTEM

(71) Applicant: HYTTO PTE. LTD., Singapore (SG)

(72) Inventors: Dan LIU, Guangzhou (CN); Jilin QIU, Guangzhou (CN)

(73) Assignee: HYTTO PTE. LTD., Singapore (SG)

(21) Appl. No.: 18/189,172

(22) Filed: Mar. 23, 2023

(51) Int. Cl. H04L 67/125; A61H 19/00

(52) U.S. Cl. CPC H04L 67/125; A61H 19/00

(57) ABSTRACT

Disclosed in the present application are an interacting system. The interacting system includes: a server and a user device, wherein the user device is configured to communicate with the server and includes an adult toy that provides sexual stimulation, and wherein the server and the user device are configured to: detect multimedia data with preset information in a network platform; generate a control instruction according to a preset rule in response to detecting of the multimedia data with preset information; and send the control instruction to the user device, to instruct the user device to perform a preset action corresponding to the multimedia data with preset information, wherein preforming the preset action includes applying the sexual stimulation by the adult toy.

### TECHNICAL FIELD

The present disclosure relates to the field of adult products, and in particular to an interacting system for adult toys.

### BACKGROUND

Nowadays, adult produces, such as adult toys, has been developed with communication functions, such that the adult toys can receive control instructions from a user terminal or other control devices to perform particular action.

It should be noted that, information disclosed in the above background portion is provided only for better understanding of the background of the present disclosure, and thus it may contain information that does not form the prior art known by those ordinary skilled in the art.

### SUMMARY

According to one aspect, the present disclosure provides an interacting system including a server and a user device, wherein the user device is configured to communicate with the server and includes an adult toy that provides sexual stimulation, and wherein the server and the user device are configured to:
detect multimedia data with preset information in a network platform;
generate a control instruction according to a preset rule in response to detecting of the multimedia data with preset information; and
send the control instruction to the user device, to instruct the user device to perform a preset action corresponding to the multimedia data with preset information,
wherein preforming the preset action includes applying the sexual stimulation by the adult toy.

According to one aspect, the present disclosure provides an interacting system including a detecting module, a user device, and a memory, wherein the user device is configured to receive signal and includes an adult toy that provides sexual stimulation, and the memory is stored therein with instructions, which when being executed by a processor, implements the detecting module, and wherein the detecting module and the user device are configured to:
detect multimedia data with preset information from network information;
generate a control instruction according to a preset rule in response to detecting of the multimedia data with preset information; and
send the control instruction to the user device, to instruct the user device to perform a preset action corresponding to the multimedia data with preset information,
wherein preforming the preset action includes applying the sexual stimulation by the adult toy.

According to one aspect, the present disclosure provides an interacting system including a server and a target user device, wherein the target user device is configured to communicate with the server and includes an adult toy that provides sexual stimulation, and wherein the server and the user device are configured to:
detect multimedia data with preset information in a network platform;
generate a control instruction according to a preset rule in response to detecting of the multimedia data with preset information; and
send the control instruction to the target user device, to instruct the target user device to perform a preset action corresponding to the multimedia data with preset information,
wherein the target user device comprises a target user terminal and a target user accessory, and the target user terminal is configured to apply for authorization to the server, to allow the target user accessory to receive the control instruction,
wherein preforming the preset action includes applying the sexual stimulation by the adult toy.

It is to be understood that both the foregoing general description and the following detailed description are exemplary and explanatory only and are not restrictive of the invention, as claimed.

This section provides a summary of various implementations or examples of the technology described in the disclosure, and is not a comprehensive disclosure of the full scope or all features of the disclosed technology.

### BRIEF DESCRIPTION OF THE DRAWINGS

FIG. 1 illustrates an embodiment of the interacting system according to the present embodiment.

FIG. 2 illustrates an embodiment of the interacting system according to the present embodiment.

FIG. 3 illustrates an embodiment of the interacting system according to the present embodiment.

FIG. 4 illustrates an embodiment of the interacting system according to the present embodiment.

FIG. 5 illustrates an embodiment of the interacting system according to the present embodiment.

FIG. 6 illustrates an application scenario in which multiple users are using the interacting system according to present embodiment.

### DETAILED DESCRIPTION

Hereinafter, embodiments of the present disclosure will be described in detail.

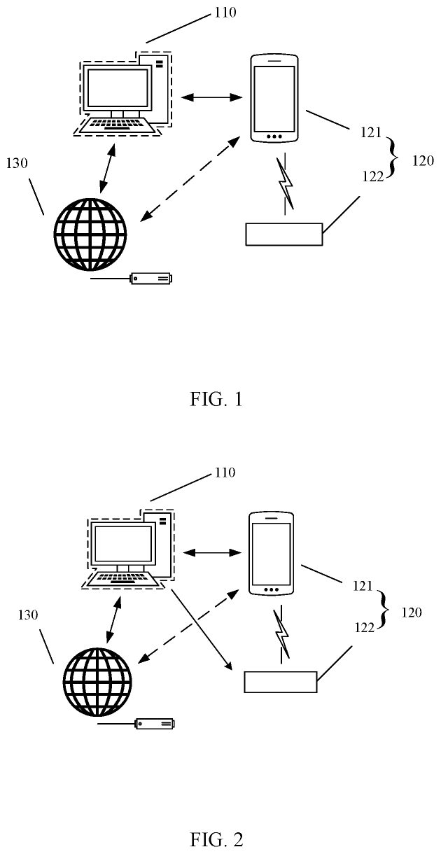

FIG. 1 illustrates an embodiment of the interacting system according to an embodiment of the present disclosure.

As shown in FIG. 1, the interacting system 100 may include: a server 110; and a user device 120, configured to communicate with the server 100. The server 110 and the user device 120 are configured to detect multimedia data with preset information in a network platform 130; generate a control instruction according to a preset rule in response to detecting of the multimedia data with preset information; and send the control instruction to the user device 120, to instruct the user device 120 to perform a preset action corresponding to the multimedia data with preset information.

In this embodiment, the user device 120 includes a user terminal 121 and a user accessory 122. It should be noted that in this embodiment, the server 110, the user terminal 121 and the user accessory 122 are illustrated as separate entities, while in other embodiments, one or more of the server 110, the user terminal 121 and the user accessory 122 can be integrated, or can be separate entities that can be assembled into one entity. In the following embodiments, the user terminal 121 and the user accessory 122 being separate entities will be described as examples. In the examples, the user accessory 122 may be understood as an acting part of the user device 120, for example, the user accessory 122 may be an adult toy, and in particular may include a dildo, a vibrator or masturbation cup.

In this embodiment, the user terminal 121 and the user accessory 122 may be configured to communicate with each other via for example near filed communication technology, e.g., Bluetooth or RF communication, or other general communication technology, e.g., WIFI, or WLAN.

The sever 110 may be configured to support multiple user devices 120, i.e., the server 110 may communicate with a plurality of different user devices 120, and send the control instructions to the plurality of different user devices 120. For example, as shown in FIG. 6, five users A, B, C, D and E are connected to the server 110, and the user terminals 121a, 121b, 121c, 121d and 121e may communicate with the server 110 and receive the control instructions send by the server 110, the user accessories 122a, 122b, 122c, 122d and 122e receives the control instructions from the corresponding user terminals, and apply sensual stimulation to the corresponding users. It should be noted that the user devices are illustrated in FIG. 6 as separate entities, while as discussed above, they can be integrated, or can be separate entities that can be assembled into one entity. Also, the network platform is not shown in FIG. 6, while corresponding description thereof may refer to similar descriptions with reference to other embodiments of the present disclosure.

For example, the user terminal 121 may communicate with the server 110, to establish a communication between the server 110 and the user device 120. The user terminal 121 may sent messages including to the server 110, wherein the messages may include for example user ID or other authentication information. The server 110 may verify this information to determine authorization to the user terminal 121 and establish a connection between the server 110 and the user device 120. In other words, the user may use the user terminal 121 to login onto the server 110.

In this way, the interacting system 100 according to the embodiment of the present invention may be applicable to an online orgy. For example, all the users joining the orgy may login to the server 110 and establish the communication connections between the server 110 and his/her user device 120, and the server 110 may start detecting the network platform when a required user is logged in.

When the server 110 detects multimedia data with preset information in a network platform, the server 110 may generate and send the control instruction to all the user devices 120, and therefore all the user devices may operate in response to the control instruction, and therefore the user device, e.g., the adult toy, may operate in a more fun and interactive way.

The multimedia data with preset information may be posted to the network platforms by other users of the network platform, or may be posted to the network platforms by the users joining the orgy. The dashed line between the user device 120 and the network platform 130 indicates this optional interacting between the user device 120 and the network platform 130.

In for example Twitter™, people usually tweet frequently with specific messages. For example, on the Thanksgiving Day, people tweet very frequently with hashtag #thanksgiving, or #thank, and therefore, the orgy may take the tweets with these hashtags as the multimedia data with preset information. Accordingly, the server may detect the Twitter™ for the tweets with these hashtags as the multimedia data with preset information, and generate corresponding control instructions according to the preset rule. Also, the orgy may be in a more personal way, and the multimedia data with preset information may be tweets posted by the users in the orgy. For examiner, the users may tweet with particular hashtags such as #ShareTheLovese, #OrgyDay, or #WorldOrgy, and the server may detect the Twitter™ for the tweets with these hashtags as the multimedia data with preset information, and generate corresponding control instructions according to the preset rule. It should be noted that the preset information may be may be a uniform information for all users, or may be set by users, and different users may set and use different preset information.

According to an embodiment, the control instruction may be a simple instruction such as “information detected”, or may be a preset identifier such as “1”, and the user device may perform preset action according to the control instruction.

According to another embodiment, the control instruction may include one or more action types and configuration for intensity and duration of each action type. In this way, the preset action may include the action type and corresponding action intensity and duration. For example, the action type may include one or more of rotate, vibrate, inflate, stretch, and the like, which may be any action type that the user device 120 may perform. Also, the intensity and duration may indicate the action intensity, e.g., level 1, level 2, or the like, and the duration of each action, i.e., 1 second, 2 seconds, or the like. In one example, if the control instruction includes the action type of rotate, intensity of level 2 and duration of 3 seconds, the user device 120 may rotate at level 2 for 3 seconds, in response to the control instruction.

In one embodiment, the control instruction may be generated whenever the multimedia data with preset information is received. In other words, each time when the multimedia data with preset information is detected by the server 110, the server 110 may generate the control instruction. For example, in the above example where tweet with hashtag #WorldOrgy is the multimedia data with preset information, the server 110 may detect the tweets on Twitter™, and each time someone posts a tweet with the hashtag #WorldOrgy, the server 110 may detect the tweet and generate the control instruction. Accordingly, all members in the orgy may enjoy the preset action performed by his/her user device 120 upon receiving the control instruction.

In other embodiments, the control instruction may be generated according to either the detected multimedia, or the preset in formation included in the detected multimedia. That is, the server 110 may generate the control instruction matching at least one of the multimedia data and the preset information. For example, the in the above example where tweets with hashtags #WorldOrgy and #ShareTheLovese are used as the multimedia data with preset information, the multimedia may be all the tweets with hashtags #WorldOrgy and/or #ShareTheLovese, and the preset information may be the hashtags #WorldOrgy and/or #ShareTheLovese. Accordingly, the server 110 may detect the tweets on Twitter™, and detecting all the tweets with the hashtags, and may generate the control instruction matching the all the tweets, or generate the control instruction matching the hashtags #WorldOrgy and/or #ShareTheLovese, or generate the control instruction matching both the tweets and the hashtags.

In some embodiments, the control instruction may be generated according to statistics information of the multimedia data with preset information. For example, the server 110 may generate the control instruction matching a count of the preset information in a preset period; or the server 110 may generate the control instruction matching a count of the multimedia data in a preset period. In particular, for example in the above example where tweets with hashtags #WorldOrgy and #ShareTheLovese are used as the multimedia data with preset information, if four tweets with hashtag #WorldOrgy are detected and three tweets with hashtag #ShareTheLovese are detected in one minute, the server 110 may generate the control instruction according to the statistics information of the detected tweets and the hashtags. For example, the server 110 may generate the control instruction matching a count of the preset information i.e., the count of the hashtag #WorldOrgy of 4, which for example may be rotating clockwise at level 3 for 10 seconds; may generate the control instruction matching a count of the preset information i.e., the count of the hashtag #ShareTheLovese of 3, which for example may be rotating counterclockwise at level 4 for 5 seconds; or may generate the control instruction matching a count of the multimedia data, i.e., the total of the tweets with the hashtags of 7, which for example may be stretching at level 5 for 10 seconds.

In some embodiments, when the count of the multimedia data and/or the preset information raises, the generated control instruction may change accordingly. For example, in the above example, when the count of the hashtag #WorldOrgy is 4, the generated control instruction includes rotating clockwise at level 3 for 10 seconds, while when the count of the hashtag #WorldOrgy is increased to for example 6, the generated control instruction may include rotating clockwise at level 3 for 12 seconds. Also, in some embodiments, the server may generate a control instruction for each multimedia data and/or the preset information. For example, when the count of the hashtag #WorldOrgy is 4, the server may generate four control instructions each including 2.5 seconds, and the user device may rotate clockwise at level 3 for totally 10 seconds after executing the four control instructions. Also, when the count of the hashtag #WorldOrgy is 6, the server may generate six control instructions each including 2 seconds, and the user device may rotate clockwise at level 3 for totally 12 seconds after executing the six control instructions. In some embodiments, different hashtags may correspond to different actions, for example, in the above example, the hashtag #WorldOrgy corresponds to rotating clockwise, while the hashtag #ShareTheLovese corresponds to rotating counterclockwise. This is not limited by the present disclosure, for example in another embodiment, the hashtag #WorldOrgy may correspond to a vibrate pattern of “Firework”, while the hashtag #ShareTheLovese may correspond to a vibrate pattern of “Wave”.

Also, it should be noted that the control instructions send to various users may be the same or may be different. For example, in the above embodiment shown in FIG. 6, if the five users A, B, C, D and E are joining the orgy, the control instruction of rotating clockwise at level 3 for 10 seconds may be send to the users A and B, the control instruction of rotating counterclockwise at level 4 for 5 seconds may be send to the users C and D, and the control instruction of stretching at level 5 for 10 seconds may be send to the user D and E. In this example, when one user receives multiple control instructions, for example, the user D receives two controlling instructions of rotating counterclockwise at level 4 for 5 seconds and stretching at level 5 for 10 seconds, the user device 120 of the user D may perform the actions successively or simultaneously. That is, the user device 120 of the user D may rotating counterclockwise at level 4 for 5 seconds and then stretching at level 5 for 10 seconds, or stretching at level 5 for 10 seconds and then rotating counterclockwise at level 4 for 5 seconds, or simultaneously rotating and stretching for 5 seconds, and followed by stretching for the rest 5 seconds. In some embodiments, in the case of simultaneously performing the actions, the duration difference may be ignored, e.g., simultaneously rotating and stretching for either 5 seconds or 10 seconds, or 15 (5+10) seconds.

In one embodiment, the control instruction may be generated according to the characteristic of the multimedia data with preset information. In this case, the server 110 may generate the control instruction according to the preset rule when a count of the multimedia data with preset information with same characteristic reaches a preset value. For example, in the above example, the characteristic of the multimedia data with preset information may be the IP address of the user posting the tweets with the hashtag #WorldOrgy, or may be geographical information of the posting the tweets. In particular, if tweets with the hashtag #WorldOrgy posed from for example Nevada reaches a number of 100, the server may generate a wild-west control instruction, which may include rotating clockwise at the maximum level for 10 seconds followed by rotating counterclockwise at the maximum level for 10 seconds and followed by stretching at the maximum level for 15 seconds. In some other embodiment, the characteristic of the multimedia data may also be other information, for example a follower identification of a particular model, and in this case, if the fans (followers) of the model post the tweets exceeding the preset threshold, the corresponding control instruction may be generated. In some other embodiment, the characteristic of the multimedia data may be a team badge, and for example the fans of each team of a match may tweet with their team badge, and when the tweets with the same team badge reaches the preset threshold, the corresponding control instruction may be generated. It can be appreciated any identifier that would be used by the users with the same interests can be selected as the characteristic.

In some embodiment, one or more pieces of multimedia data may be detected, which may include one or more pieces of preset information. In this case, one or more control instructions may be generated according to the one or more pieces of multimedia data and/or the one or more pieces of preset information. Detailed implementation of the embodiment may refer to the examples discussed above with reference to tweets with particular hashtags, and therefore repeated description will be omitted.

In some embodiments, the multimedia data may include one or more pieces of preset information, and the control information may be generated according to the one or more pieces of preset information. That is, the server 110 may generate one or more control instructions matching the multimedia data comprising the one or more pieces of preset information according to the preset rule. In one embodiment, the multimedia data may include a first preset information and a second preset information, and the server 110 may generate the control instruction when detecting the multimedia data including both the first preset information and the second preset information.

For example, the first preset information may be the hashtag discussed above, and the second preset information may be a password, which may be a preset keyword, or the correct answer to a preset question. In this way, the server may detect the tweet with both the hashtag and the password, and generate the control instruction when the tweet with both the hashtag and the password is detected.

In some embodiments, when the server 110 may be configured to generate a special control instruction when the multimedia data with preset information satisfies a preset requirement, and generate a general control instruction when the multimedia data with preset information does not satisfy a preset requirement. For example, in the above example, when the detected tweet includes both the hashtag and the answer to the question, the server 110 may generate the special control instruction, e.g., a reward control instruction which may have more fun, in response to the tweet with the correct answer, while generate the general control instruction in response to the tweet with the incorrect answer. Similarly, the server 110 may generate the special control instruction, e.g., a punishment control instruction which may have less fun, in response to the tweet with the incorrect answer, and may generate the general control instruction in response to the tweet with the correct answer. For another example, in some other embodiments, the preset requirement may also be other requirements such as the count of the multimedia data within a preset period reaches a preset value; or the count of the preset information within a preset period reaches a preset value; or the count of the multimedia data having same characteristic within a preset period reaches a preset value. For example, when the count of the multimedia data posted from Nevada is less than 100, a general control instruction is generated, while when the count of the multimedia data posted from Nevada reaches 100, the special control instruction, i.e., the wild-west control instruction, is generated.

In some examples, if the control instructions generated according for example the above examples are send to the user devices 120, the user devices 120 may perform the preset action according to the control instruction and the capability of the user devices 120. In this embodiment, the user devices 120 may perform at least one type of the preset action when the user device 120 has at least one capability corresponding to the preset action. For example, when the control instruction instructs to rotate clockwise at level 5 for 10 seconds, and the user device receiving the control instruction has the capability of performing such action, the user device may perform the preset action according to the control instruction, to rotate clockwise at level 5 for 10 seconds. However, if the user device 120 do not have the capability of performing such action, the user device may ignore the control instruction. It should be noted that the user device ignoring the control instruction may include ignoring at least part of the control instruction. For example, when the control instruction instructs to rotate clockwise at level 5 for 10 seconds, and the user device receiving the control instruction, while the user device 120 can rotate only counterclockwise and has a maximum level of 3, the user device may ignore part of the control instruction, and rotates in its own direction at the maximum level 3 for 10 seconds, or, the user device may ignore the entire control instruction, and perform no action. In another embodiment, the ignoring the control instruction may include performing only a default operation of the user device 120, such as vibrating. In this way, all the users may be provided with the same control instruction, regardless of whether they have the same or different sex toys.

Hereinafter, an example for hosting an orgy using the interacting system of the present disclosure will be described in detail. The orgy may be referred to as a “WorldOrgy”, and the server 110 is configured to detect the Tweet™ for the posed tweets with hashtags #ShareTheLovese, #OrgyDay, or #WorldOrgy. The user joining the orgy users their user device 120 to receive control instructions from the server 110. When the tweets with hashtags #ShareTheLovese, #OrgyDay, or #WorldOrgy are detected, each tweet is generated with a control instruction to instruct the user device 120 to vibrate to apply sexual stimulation to the user. In case where an ongoing vibration is performing, the newly generated control instruction may be put into a waiting list to be processed later. Each control instruction may include a vibration duration and a vibration type.

The vibration duration may be configured in the range of: 5 seconds, 4 seconds, 3 seconds, 2 seconds, 1 second, and 0.5 second. In the case where no ongoing vibration is performing, the vibration duration is set to 5 seconds when a tweet with the hashtags is detected; also, if multiple users post the tweet with the hashtag at the same time, the vibration durations corresponding to the tweets are all set to 5 seconds. In the case where an ongoing vibration is performing, the waiting list is checked after the ongoing vibration is finished to determine the duration of the next control instruction. For example, after the ongoing vibration is finished, the waiting list of control instruction is checked, if the number of control instruction is 0, no vibration is set; if the number of control instruction is 1, the one vibration is set to 4 seconds; if the number of control instructions is 2, the two vibrations are respectively set to 3 seconds; if the number of control instructions is 3, the three vibrations are respectively set to 2 seconds; if the number of control instructions is 4, the four vibrations are respectively set to 1 seconds; if the number of control instructions is equal to or greater than 5, each of the vibrations are set to 0.5 seconds.

The vibration type may be determined according to the hashtag, for example, the hashtag #WorldOrgy may correspond to a vibrate pattern of “Firework”, while the hashtag #ShareTheLovese may correspond to a vibrate pattern of “Wave”.

For other durations from e.g., 3 seconds to 0.5 second, the vibration intensity is randomly set to Low, Medium or High, for each duration.

It should be noted that in the above embodiments, the network platform of Tweeter™ is used as example, while the present disclosure is not limited to detecting tweets on Tweeter™. The network platform according to the embodiments of the present discloser may include at least one of a multimedia platform, a social platform, a statistical platform or a detecting platform. Accordingly, the preset information may include other information than the hashtag, for example, the preset information may include one or more of preset keyword, emoticon, character string, image signal, audio signal, video signal. For example, the preset information may be particular keywords posed on the SNS platform such as Tweeter™ or Facebook™, or an image or voice sent in a chatroom, or a video posed on a sharing platform such as Youtube™ or TikTok™ or comments posed for the video, or other preset information such as a goal in a soccer live broadcast, or a preset action of the model in a live show, or certain information on a decentralized platforms, or the like. In some embodiment, the network platform may also be a virtual scene or an online gaming scene, and the server may detect particular items or actions in the scene and generate corresponding control instruction. For example, during a soccer game, the server 110 may detect predetermined information from a network platform providing the information of the soccer game, which may be for example a sports live platform, or a network platform for statistics of the game. In this case, the preset information may be for example a successful pass, a slide tackle, a shot on target, a goal, or other actions such as offset, corner kick, free kick, penalty kick or the like, and generate the same or different control instructions, to control the user device 120 to apply sexual stimulation to the users. Also, the server 110 may change the stimulation (e.g., by sending different control instructions) according to different actions, or the count of a particular action. For another example, in a live show, the sever the server 110 may detect predetermined information from the live show platform, e.g., the movement of the model such as gestures, movement of a certain part of the body or movement of the whole body. In this case, when the model performs a particular action, such as a sexually suggestive action which meets the predetermined information, the server may generate a corresponding control instruction to control the user device 120 to apply sexual stimulation to the users. In some other embodiments, the server 110 may detect instant messenger applications and generate the control instructions according to the particular multimedia of the user's chat. Generally, the instant messenger applications are partite and the messenger server is not available to the public, and thus the server 110 cannot obtain the chat information from the messenger server. In this case, the server 110 may be implemented by an application or a functional module of the application installed on the user terminal 121, and when authorized by the user, the application or functional module may obtain the chat information from the user terminal 121. Details of the server 110 mounted in the user terminal 121 will be described later with reference to FIG. 4 of the present disclosure.

In the embodiment shown in FIG. 1, the user device 120 includes the user terminal 121 and the user accessory 122, and the user terminal is configured to communicate with the server 110 to apply for authorization to the server 110, and if granted, to receive the control instruction sent by the server 110. The control instruction is then forward to the user accessory 122 by the user terminal 121. After receiving the control instruction, the user accessory 122, e.g., the adult toy, performs corresponding action according to the control instruction. However, the present disclosure is not limited thereto.

FIG. 2 illustrates an embodiment of the interacting system according to the present embodiment. As shown in FIG. 2, in this embodiment, the user device 120 includes the user terminal 121 and the user accessory 122, and the user terminal is configured to communicate with the server 110 to apply for authorization to the server 110, and if granted, a connection is established between the server 110 and the user accessory 122. Accordingly, in this embodiment, the control instruction is transmitted to the user accessory 122 according to the authorization, and thus the user accessory 122, e.g., the adult toy, receives the control instruction directly form the server 110 and performs corresponding action according to the control instruction.

In this embodiment, the user accessory 122 may be provided with remote communication modules such as 3G/4G/5G modules, which, when being authorized by the server 110, may establish the connection between the server 110 and the user accessory 122, to receive the control instruction sent from the server 110.

Other details of the embodiment can refer to the previous embodiment discussed with reference to FIG. 1, which will not be repeated herein.

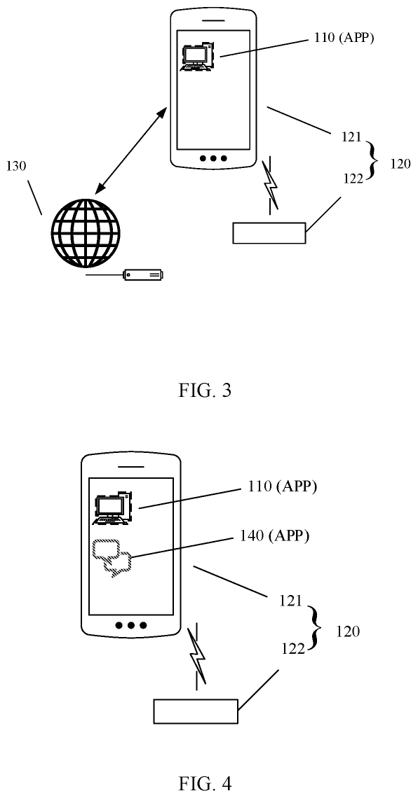

FIG. 3 illustrates an embodiment of the interacting system according to the present embodiment. As shown in FIG. 3, in this embodiment, the user device 120 includes the user terminal 121 and the user accessory 122, and the server 110 discussed in the above embodiments is implemented by an application installed on the user terminal 121.

In this embodiment, the server 110 is integrated into the user terminal 121, and the function of the server 110 is implemented by an application or a functional module of the application installed on the user terminal 121. For example, a detecting application is provided and installed on the memory of the terminal 121, and when the detecting application is executed, the interacting system may detect multimedia data with preset information in from network information; generate a control instruction according to a preset rule in response to detecting of the multimedia data with preset information; and send the control instruction to the user device, to instruct the user device to perform a preset action corresponding to the multimedia data with preset information. In particular, in this case, the detecting application generates and sends the control instruction to the user device 120 may be particularly implemented by sending the control instruction to the connection management application between the user terminal 121 and the user accessory 122, and thus the control instruction is send to the user accessory 122, e.g., the adult toy, to instruct the adult toy to perform the preset action. Further, the network information may be information published in a network platform discussed above. Alternatively, as shown in FIG. 4, the network information may be information published in a network application 140. For example, the network application may be an instant messenger application such as Telegram™, Wechat™, WhatsAPP™ or the like installed in the user terminal 121, and the server 110, which may be an independent detecting application or a functional module or a plug-in or an extension of the application, may be configured to detect the data of the instant messenger application.

Other details of the embodiment can refer to the previous embodiment discussed with reference to FIG. 1, which will not be repeated herein.

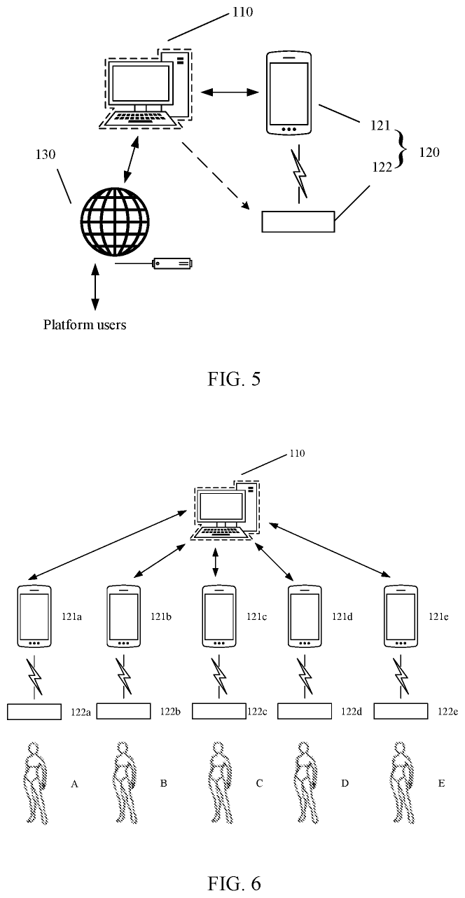

FIG. 5 illustrates an embodiment of the interacting system according to the present embodiment. As shown in FIG. 5, in this embodiment, the user device 120 is owned by some other user (i.e., a target user), and the user device 120 is logged in to the server 110 and the connection is established between therebetween. In this embodiment, the user device 120 is referred to as a target user device for clarity. In this case, when the user of the platform posts the multimedia data with preset information, the server 110 may detect the multimedia data with preset information and generate the corresponding control instruction, and send the control instruction to the target user device, to instruct the target user device to perform a preset action corresponding to the multimedia data with preset information. In this embodiment, as discussed in the previous embodiments, the target user device may include the target user terminal 121 and the target user accessory 122, and the target user terminal 121 is configured to apply for authorization to the server 110, to allow the target user accessory 122 to receive the control instruction.

It should be noted that in this embodiment, allowing the target user accessory 122 to receive the control instruction may be implemented by establishing direction connection between the user accessory 122 and the server 110, similar to the embodiment of FIG. 2, and may also be implemented by sending the control instruction to the user terminal 121 and then forwarding the control instruction to the user accessory 122 by the user terminal 121, which is mot limited by the present disclosure.

Other details of the embodiment can refer to the previous embodiment discussed with reference to FIG. 1, which will not be repeated herein.

It should be appreciated that, the above embodiments are exemplary implementations for illustrating the principle of the present disclosure only, while the present disclosure is not limited thereto. Various modifications and improvements are possible to those of ordinary skill in the art without departing from the spirit and essence of the present disclosure. All these modifications and improvements will also fall into the protection scope of the present disclosure.

What is claimed is:

1. An interacting system, comprising a server and a user device, wherein the user device is configured to communicate with the server and comprises an adult toy that provides sexual stimulation, and wherein the server and the user device are configured to:
detect multimedia data with preset information in a network platform;
generate a control instruction according to a preset rule in response to detecting of the multimedia data with preset information; and
send the control instruction to the user device, to instruct the user device to perform a preset action corresponding to the multimedia data with preset information,
wherein preforming the preset action comprises applying the sexual stimulation by the adult toy.

2. The interacting system according to claim 1, wherein the control instruction comprises one or more action types and configuration for intensity and duration of each action type, and
the preset action comprises an action type and corresponding action intensity and duration.

3. The interacting system according to claim 1, wherein generating the control instruction according to the preset rule in response to detecting of the multimedia data with preset information comprises:
generating the control instruction whenever the multimedia data with preset information is detected.

4. The interacting system according to claim 1, wherein generating the control instruction according to the preset rule in response to detecting of the multimedia data with preset information comprises:
generating the control instruction matching at least one of the multimedia data and the preset information.

5. The interacting system according to claim 4, wherein the generating the control instruction matching at least one of the multimedia data and the preset information comprises:
generating the control instruction matching a count of the preset information in a preset period; or
generating the control instruction matching a count of the multimedia data in a preset period.

6. The interacting system according to claim 4, wherein the generating the control instruction matching at least one of the multimedia data and the preset information comprises:
obtaining a characteristic of the multimedia data with preset information; and
generating the control instruction according to the preset rule when a count of the multimedia data with preset information with same characteristic reaches a preset value.

7. The interacting system according to claim 6, wherein the characteristic comprises at least one of IP address and geographical information.

8. The interacting system according to claim 1, wherein generating the control instruction according to the preset rule comprises:
generating one or more control instructions matching one or more pieces of multimedia data according to the preset rule; or
generating one or more control instructions matching one or more pieces of preset information according to the preset rule.

9. The interacting system according to claim 1, wherein generating the control instruction according to the preset rule comprises:
in a case where one piece of the multimedia data comprises one or more pieces of preset information, generating one or more control instructions matching the multimedia data comprising the one or more pieces of preset information according to the preset rule.

10. The interacting system according to claim 9, wherein generating the control instruction according to the preset rule comprises:
in a case where one piece of the multimedia data comprises a first preset information and a second preset information, generating the control instruction according to the preset rule.

11. The interacting system according to claim 2, wherein the user device is further configured to:
perform at least one type of the preset action when the user device has at least one capability corresponding to the preset action.

12. The interacting system according to claim 1, wherein the network platform comprises at least one of a multimedia platform, a social platform, a statistical platform or a detecting platform.

13. The interacting system according to claim 1, wherein the preset information comprises one or more of preset keyword, emoticon, character string, image signal, audio signal, video signal.

14. The interacting system according to claim 1, wherein the user device comprises a user terminal and a user accessory, the user terminal is configured to apply for authorization to the server, and the user accessory comprises the adult toy and is configured to perform the preset action corresponding to the multimedia data with preset information according to the control instruction, and
wherein:
the control instruction is transmitted to the user accessory according to the authorization; or
the control instruction is transmitted to the terminal according to the authorization, and the terminal is configured to forward the control instruction to the user accessory.

15. The interacting system according to claim 1, wherein the control instruction comprises a general control instruction and a special control instruction, and wherein:
the special control instruction is generated in response to the multimedia data with preset information satisfying a preset requirement; and
the general control instruction is generated in response to the multimedia data with preset information not satisfying the preset requirement.

16. The interacting system according to claim 15, wherein the preset requirement comprises:
a count of the multimedia data within a preset period reaches a preset value; or
a count of the preset information within a preset period reaches a preset value; or
a count of the multimedia data having same characteristic within a preset period reaches a preset value.

17. The interacting system according to claim 1, wherein the detecting multimedia data with preset information in the network platform comprises:
detecting, by the server, the multimedia data posed on the network platform by at least one user; and
determining, by the server, whether the multimedia data comprises the preset information.

18. An interacting system, comprising a detecting module, a user device, and a memory, wherein the user device is configured to receive signal and comprises an adult toy that provides sexual stimulation, and the memory is stored therein with instructions, which when being executed by a processor, implements the detecting module, and wherein the detecting module and the user device are configured to:
detect multimedia data with preset information from network information;
generate a control instruction according to a preset rule in response to detecting of the multimedia data with preset information; and
send the control instruction to the user device, to instruct the user device to perform a preset action corresponding to the multimedia data with preset information,
wherein preforming the preset action comprises applying the sexual stimulation by the adult toy.

19. The interacting system according to claim 18, wherein the network information comprises information published in a network platform, or information published in a network application.

20. An interacting system, comprising a server and a target user device, wherein the target user device is configured to communicate with the server and comprises an adult toy that provides sexual stimulation, and wherein the server and the user device are configured to:
detect multimedia data with preset information in a network platform;
generate a control instruction according to a preset rule in response to detecting of the multimedia data with preset information; and
send the control instruction to the target user device, to instruct the target user device to perform a preset action corresponding to the multimedia data with preset information,
wherein the target user device comprises a target user terminal and a target user accessory, and the target user terminal is configured to apply for authorization to the server, to allow the target user accessory to receive the control instruction,
wherein preforming the preset action comprises applying the sexual stimulation by the adult toy.
